(19) United States
(12) Patent Application Publication
(10) Pub. No.: US 2010/0218962 A1
(43) Pub. Date: Sep. 2, 2010

(54) FIRE CONTAINMENT AND MONITORING SYSTEM

(75) Inventors: David Robb, Las Vegas, NV (US); Ola Stein Harsheim, Henderson, NV (US)

Correspondence Address: Cislo & Thomas LLP, 1333 2nd Street, Suite #500, Santa Monica, CA, 90401-4110, US

(73) Assignee: Oceano de Dios SA

(21) Appl. No.: 12/714,329

(22) Filed: Feb. 26, 2010

Related U.S. Application Data
(60) Provisional application No. 61/208,760, filed on Feb. 27, 2009.

(51) Int. Cl. A62C 3/10; A62C 2/00

(52) U.S. Cl. 169/46; 169/62

(57) ABSTRACT

A fire containment and monitoring system includes a control system that communicates with a fire protection system and an array of alarms, smoke detectors, heat detectors, ventilation dampers, fire dampers, fire doors, and manual call points. The system has particular usefulness for kitchens onboard watercraft, especially large ships, where fire containment is critical to the survivability of the vessel, passengers, crew, and cargo. The control system communicates with the alarms, smoke detectors, heat detectors, ventilation dampers, fire dampers, fire doors, manual call points, and fire protection system, and it initiates a comprehensive list of actions if a smoke detector, a heat detector, or a manual call point is triggered within the monitoring portion of the system.

### CROSS-REFERENCES TO RELATED APPLICATIONS

This patent application claims the benefit of U.S. Provisional Patent Application Ser. No. 61/208,760 filed Feb. 27, 2009 for FIRE CONTAINMENT AND MONITORING SYSTEM, which application is incorporated here by this reference.

### TECHNICAL FIELD

This invention relates to systems for providing monitoring and containment of fire, smoke, heat, and fumes, particularly those systems onboard watercraft.

### BACKGROUND ART

A fire on a watercraft, and the smoke, heat, and fumes generated by such a fire, poses a very serious risk for the passengers and crew as well as to the vessel itself. To complicate matters, a watercraft typically carries a large quantity of fuel and other combustible materials in close proximity to people and sensitive equipment. This problem is magnified in large passenger ships, particularly those that include kitchen areas in passenger compartments, like those found in shipboard residential apartments and condominiums.

Since existing devices and methods do not provide a complete solution for those problems, there is a need for an onboard, comprehensive, fire containment and monitoring system that includes a control system to communicate with a fire protection system and an array of alarms, smoke detectors, heat detectors, ventilation dampers, fire dampers, fire doors, and manual call points.

### DISCLOSURE OF INVENTION

The inventive fire containment and monitoring system of the present application includes a control system that communicates with a fire protection system and an array of alarms, smoke detectors, heat detectors, ventilation dampers, fire dampers, fire doors, and manual call points. The inventive system has particular usefulness for a kitchen unit onboard a watercraft, especially a large ship, where fire containment is critical to the survivability of the vessel, passengers, crew, and cargo. The system is especially beneficial for large ships having numerous residential apartments or condominiums.

Generally, the inventive system can be thought of as a fire containment and monitoring system for use onboard a watercraft having a passenger apartment, the apartment having a kitchen unit with an oven and stove area and an exhaust duct, where the fire containment and monitoring system has an alarm, a smoke detector, a heat detector, a ventilation damper, a fire damper, a fire door, an annunciator, a fire protection system, and a control system.

The alarm has an alert indicator of a possible emergency situation in an affected area. The alert indicator is audible or visual.

The smoke detector is in the passenger apartment and is configured to measure a detected smoke level and generate a smoke detector signal when the detected smoke level increases above a preselected smoke limit.

The heat detector is in the passenger apartment and is configured to measure a detected heat level and generate a heat detector signal when the detected heat level increases beyond a preselected heat limit.

The ventilation damper is in the passenger apartment and is configured to control the flow of ventilation air to and from the kitchen unit.

The fire damper is in the exhaust duct for the kitchen unit and is configured to block exhaust and embers from passing out of the kitchen unit through the exhaust duct.

The fire door is retractable and is configured to deploy automatically to enclose the oven and stove area. The fire door is configured to slide open to permit access to the oven and stove area and slide closed to seal off the oven and stove area from the remainder of the kitchen unit.

The annunciator is configured to indicate a status of the alarm, smoke detector, heat detector, ventilation damper, fire damper, and fire door.

The fire protection system cools and depletes oxygen from the affected area and has an array of nozzles for spraying water.

The control system is in communication with the fire protection system and the alarm, the smoke detector, the heat detector, the ventilation damper, the fire damper, and the fire door. The control system is configured to receive the smoke detector signal, and the heat detector signal, and the control system is also configured to initiate a responsive action upon receiving the smoke detector signal, or the heat detector signal.

No other system provides a comprehensive fire control and monitoring system able to detect and manage emergency situations and isolate potentially catastrophic fires, smoke, fumes, and heat onboard watercraft.

### BRIEF DESCRIPTION OF DRAWINGS

FIG. 1 is a schematic representation of a version of the fire containment and monitoring system.

FIG. 2 is table showing possible causes and possible related effects for operation of a version of the fire containment and monitoring system.

FIGS. 3A-3I are schematic depictions of several of the possible causes and possible related effects shown in FIG. 2. The legend for FIGS. 3A-3I is shown with FIG. 3A.

FIG. 4 is a schematic depiction of a version of a fire door for use with the fire containment and monitoring system.

FIG. 5 is a schematic depiction of a version of a kitchen unit built out with a fire door and other fire containment features for a version of the fire containment and monitoring system.

FIGS. 6A-6E are graphical representations of a version of a kitchen unit built out with a fire door and other fire containment features for a version of the fire containment and monitoring system.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

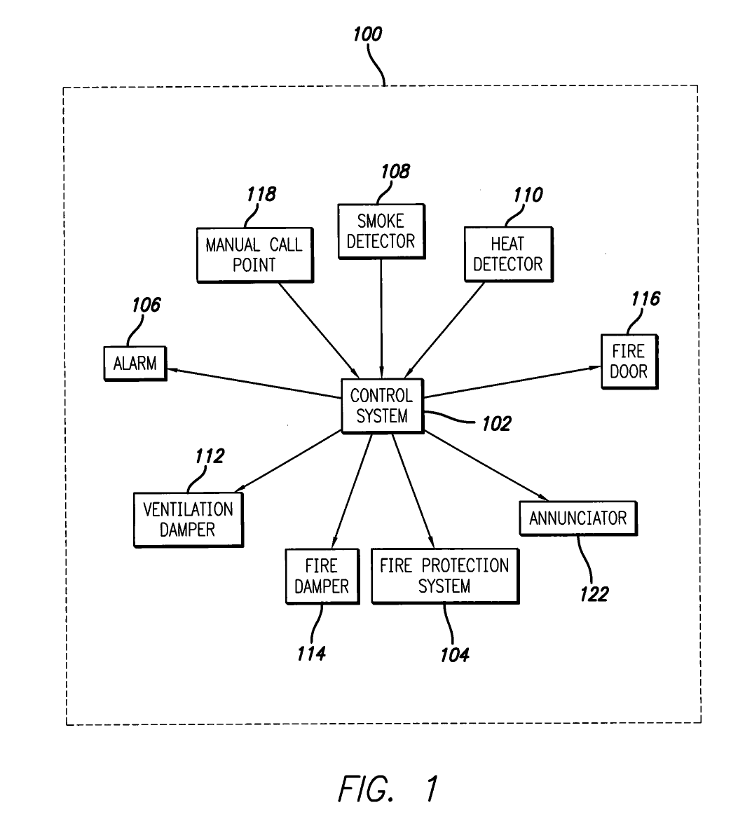

Referring to the figures, the inventive fire containment and monitoring system 100 of the present application includes a control system 102 that communicates with a fire protection system 104 (indicated schematically by sprinkler nozzles 138) and an interconnected array of alarms 106, smoke detectors 108, heat detectors 110, ventilation dampers 112, fire dampers 114, fire doors 116, and manual call points 136. The general relationship between these components is shown in FIG. 1. The arrows between the components in FIG. 1 show the direction of the typical signal flow between the components, as further described below.

The inventive system has particular usefulness for kitchen units 120 onboard watercraft, especially large ships, where fire containment is critical to the survivability of the vessel, passengers, crew, and cargo. An annunciator 122, for example a screen or panel, for the fire containment and monitoring system 100 may be located in the ship's bridge, emergency control room (ECR), or both to indicate the status of each alarm 106, smoke detector 108, heat detector 110, ventilation damper 112, fire damper 114, fire door 116, and manual call point 118.

In a version of the invention, the fire containment and monitoring system 100 includes only the control system 102, the fire protection system 104, an alarm 106, a smoke detector 108, a heat detector 110, a ventilation damper 112, a fire damper 114, and a fire door 116.

The control system 102 communicates with each alarm 106, smoke detector 108, heat detector 110, ventilation damper 112, fire damper 114, fire door 116, and manual call point 118 as well as with the fire protection system 104. The control system 102 initiates a comprehensive list of actions if a smoke detector 108, a heat detector 110, or a manual call point 118 is triggered within the monitoring portion of the fire containment and monitoring system 100.

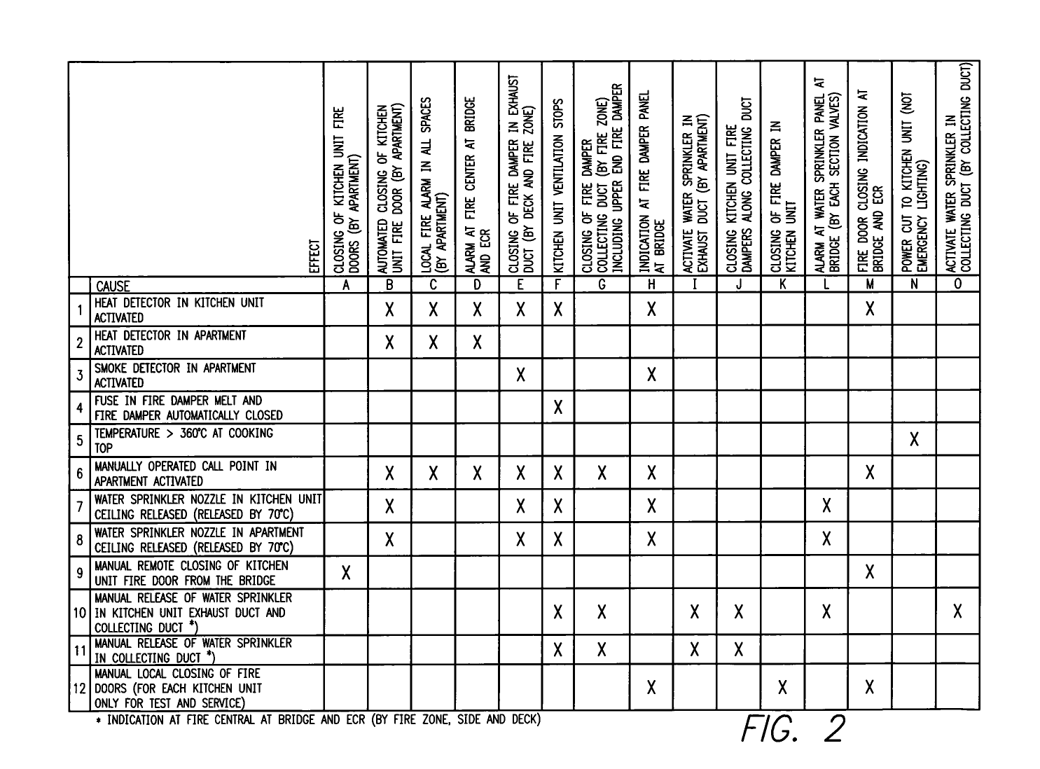

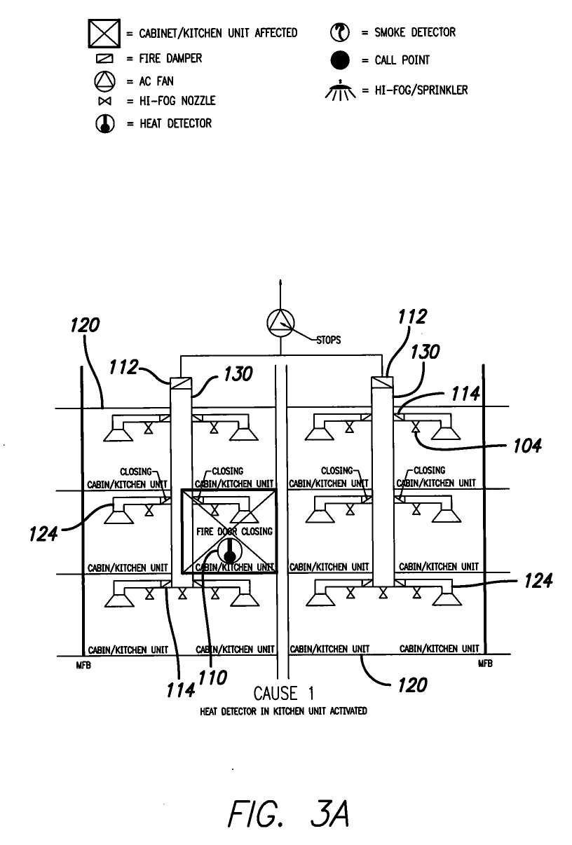

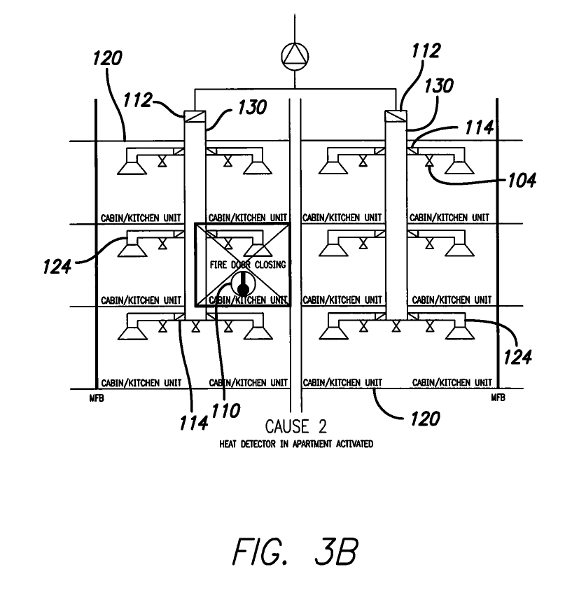

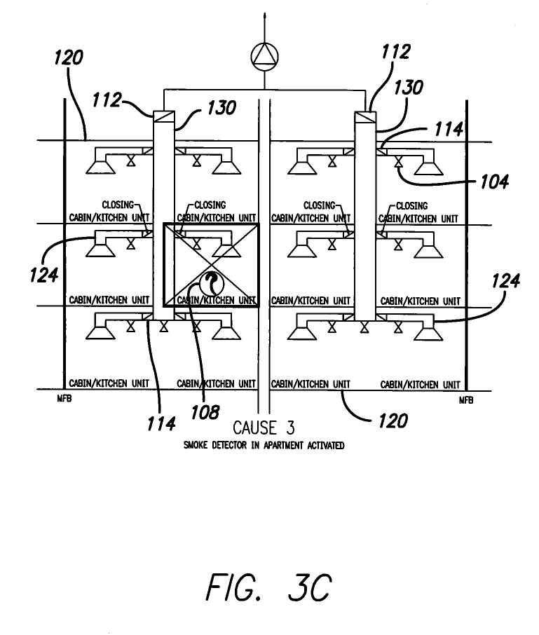

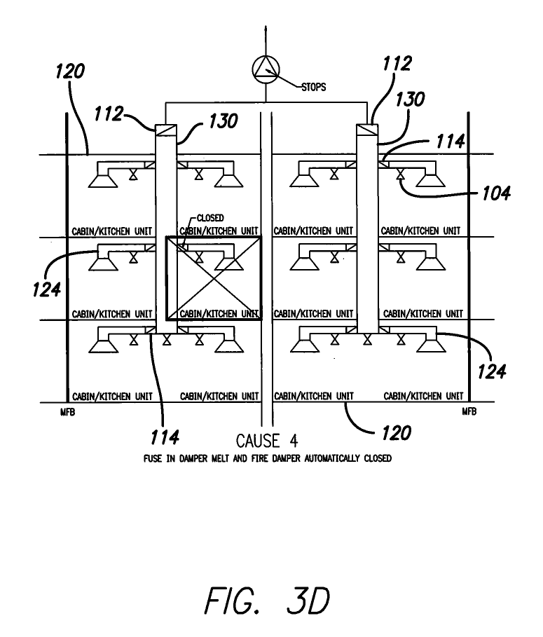

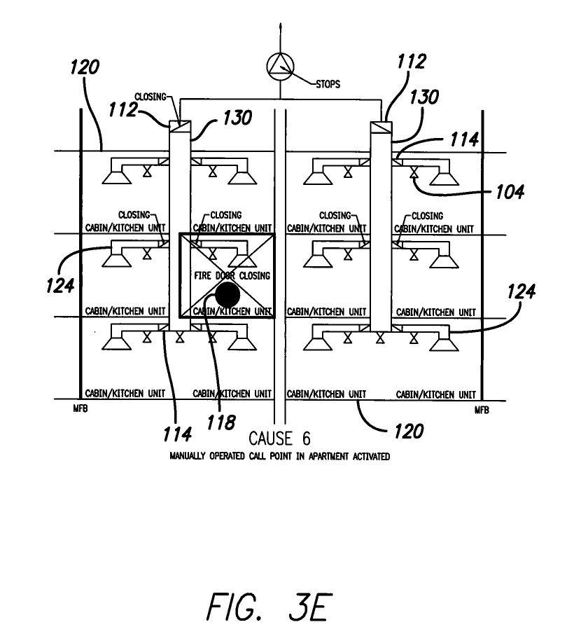

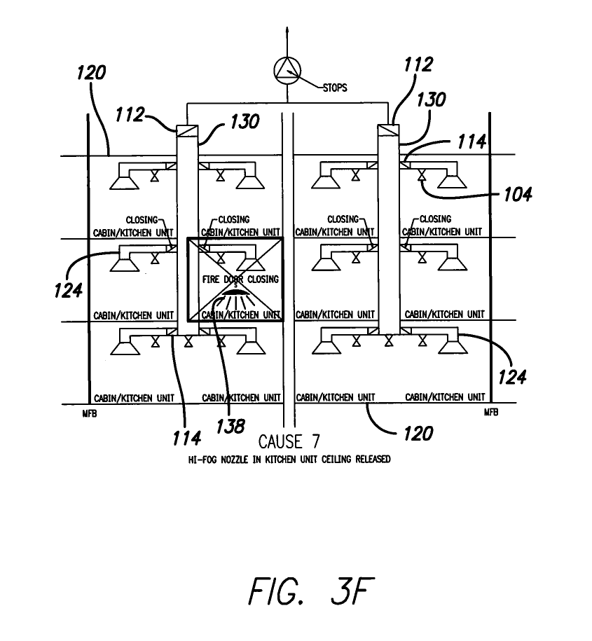

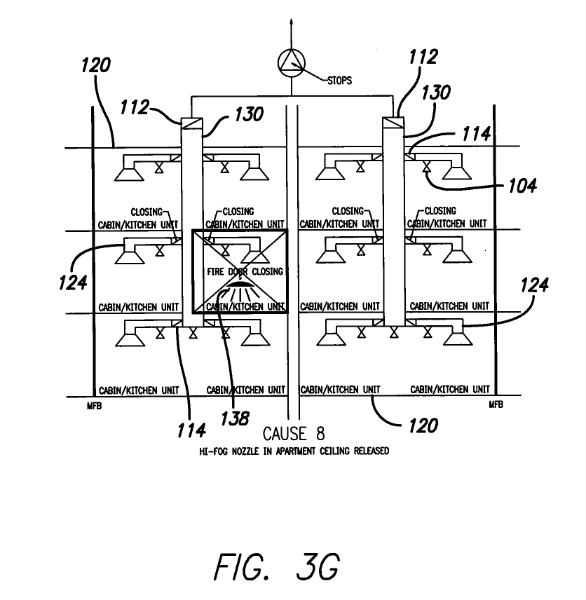

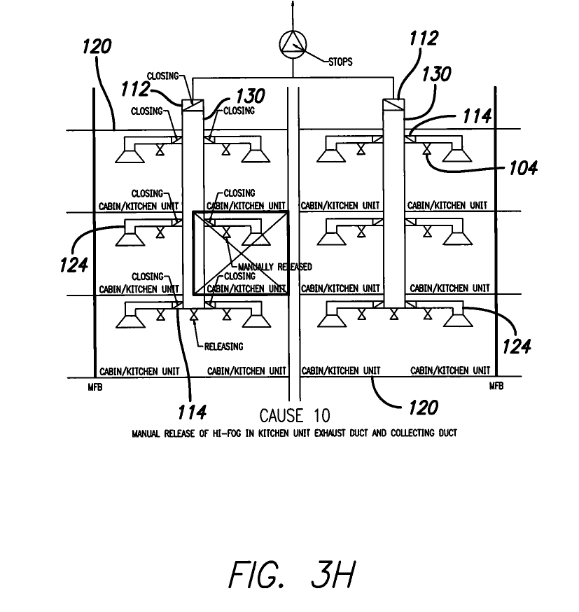

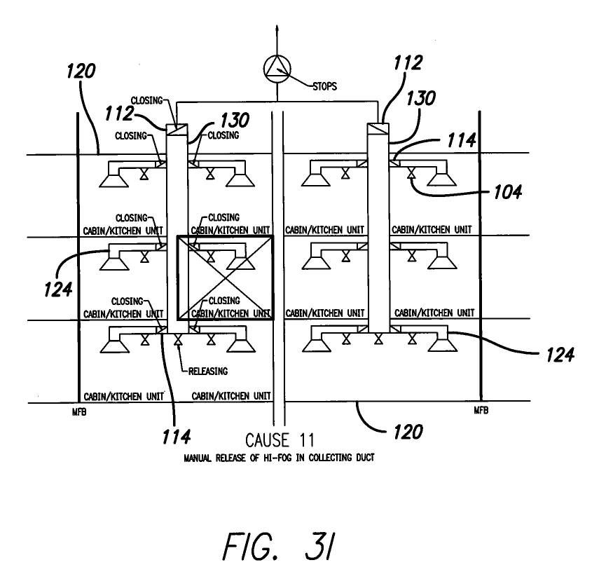

A possible matrix of these actions for a version of the fire containment and monitoring system 100 is shown in FIG. 2, which depicts twelve possible causes and fifteen possible related effects. An “X” in a column indicates which effects preferably result from which causes for this version of the fire containment and monitoring system 100. Nine of those possible causes and their related effects (corresponding to causes 1-4, 6-8, 10, and 11 from FIG. 2) are also shown graphically in FIGS. 3A-3I.

For example, when a heat detector 110 in a kitchen unit 120 activates, the kitchen unit's fire door 116 automatically closes, a local alarm (one of the array of alarms 106) is triggered in the affected space, another one of the array of alarms 106 triggers at the fire center at the ship's bridge and the emergency control room, the fire damper 114 in the exhaust duct 124 closes, the ventilation damper 112 stops the kitchen unit's ventilation, an indicator appears at the annunciator 122 showing a fire damper 114 closed, and an indicator appears at the annunciator 122 showing a fire door 116 closed. Under certain circumstances, the control system 102 might also cut electrical power to the kitchen unit 120 while maintaining emergency lighting, activate sprinklers 138 in one or more locations, and close other fire dampers 114 near the affected area.

The smoke detectors 108 and heat detectors 110 are located in critical areas, such as in each kitchen unit 120, and they detect smoke and heat, respectively. When those measured components increase beyond a safe or preselected limit, the smoke detector 108 or heat detector 110 sends a signal to the control system 102, accordingly. Preferably, one of the heat detectors 110 is positioned to detect heat at a cooking top 126 for the oven and stove area 128 within the kitchen unit 120.

The alarms 106 provide an audible or visual indicator of a possible emergency situation (smoke, fire, fumes, or excessive heat) to those in the vicinity of the situation and those monitoring the control system 102 in the ship's bridge, emergency control room, or both.

The ventilation dampers 112 control the flow of ventilation air to and from an affected area, such as a kitchen unit 120 and its vicinity. When a ventilation damper 112 is closed, ventilation air cannot pass beyond the damper 112, and the kitchen unit 120 and its vicinity are no longer ventilated. When the ventilation damper 112 is open, ventilation air can freely flow past the damper 112 to ventilate the kitchen unit 120 and its vicinity.

The fire dampers 114 are typically located in an exhaust duct 124 for a kitchen unit 120. When a fire damper 114 is open, the kitchen unit 120 is freely exhausted to the outside, such as through a chimney 130. When the fire damper 114 is closed, exhaust, air, and embers cannot pass from the kitchen unit 120 through the exhaust duct 124, which prevents fire from escaping the affected kitchen unit 120 via the exhaust duct 124. Since exhaust from multiple kitchen units 120 may be vented to common chimney 130, the fire dampers 114 for other kitchen units 120 within the same fire zone (such as kitchen units 120 in adjacent apartments) may also be closed. This is depicted in table form and graphically in FIG. 2 and FIGS. 3E, 3H, and 31, respectively, for causes 6, 10, and 11.

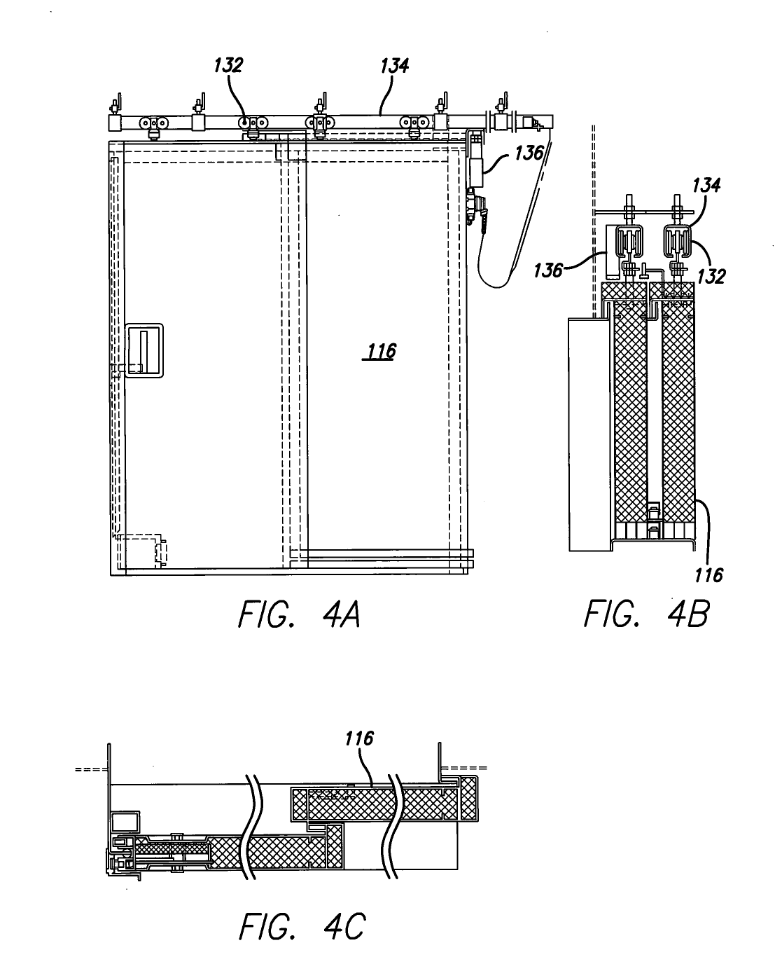

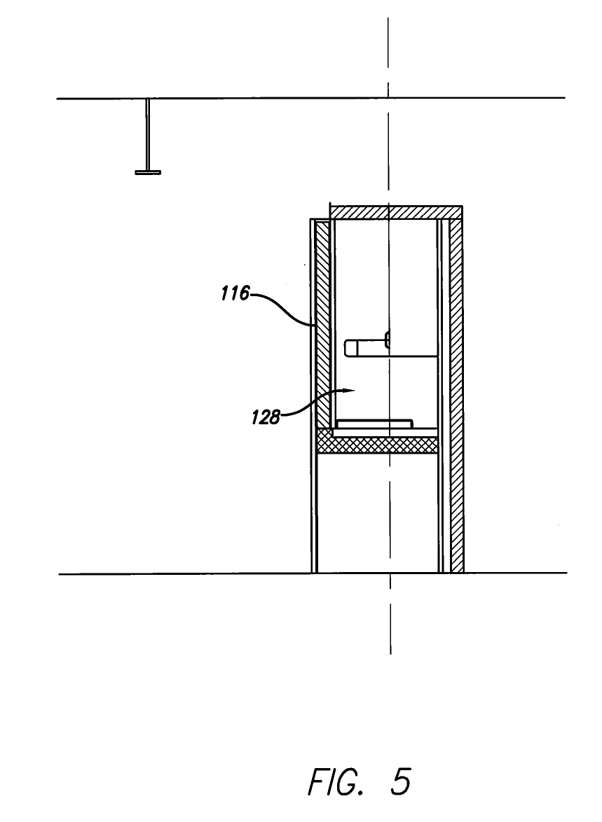

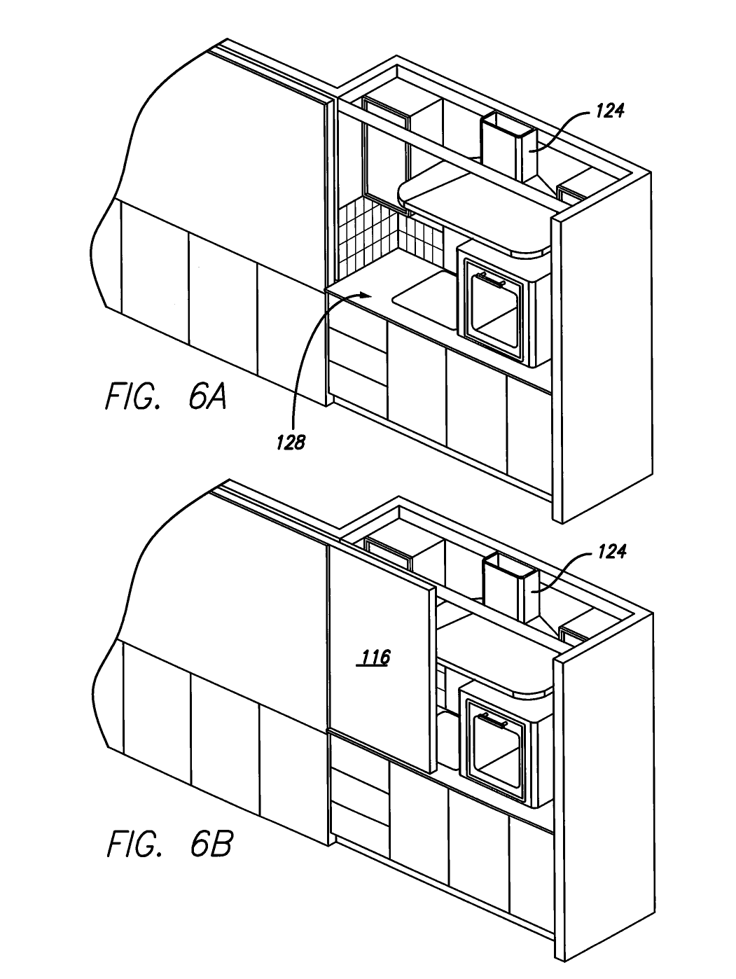

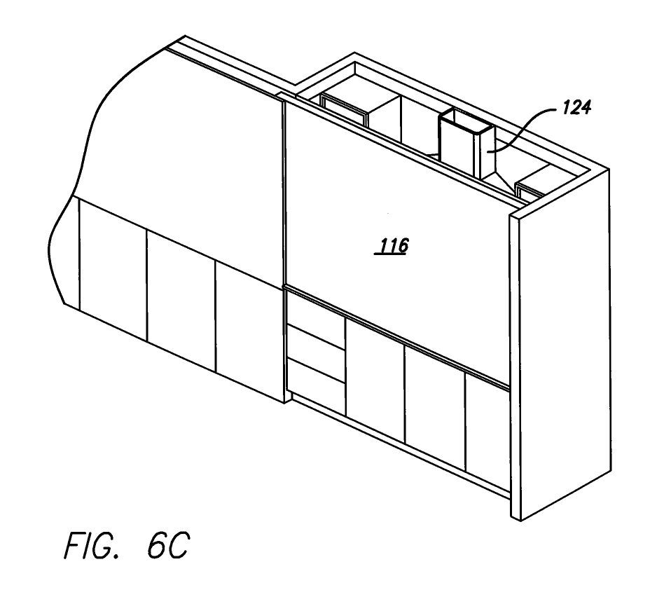

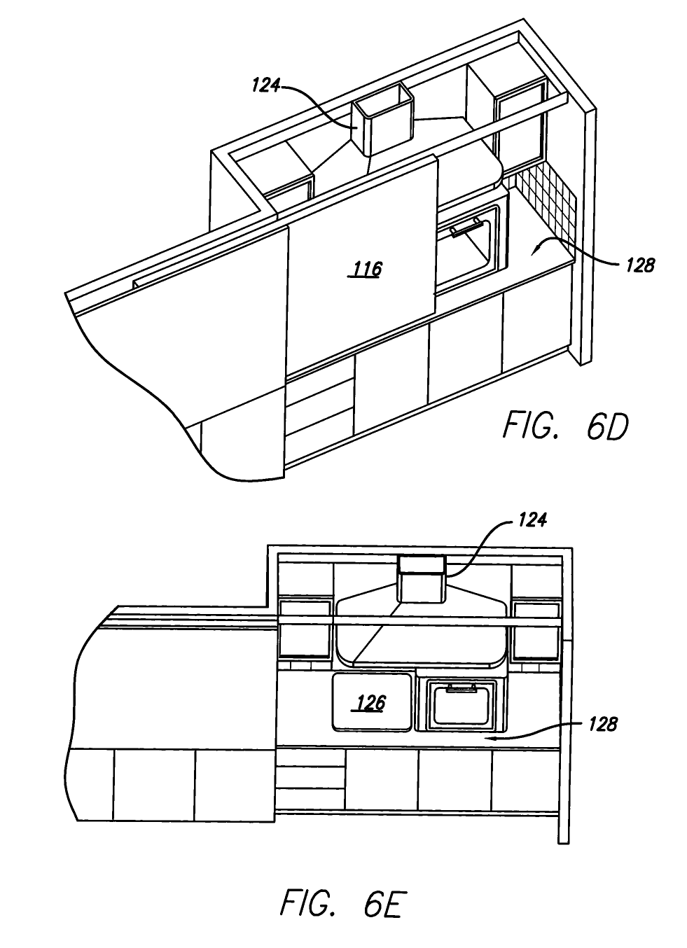

The fire door 116 is preferably a retractable fire door to be used in the kitchen units 120. The fire door 116 preferably deploys automatically around the oven and stove area 128 within the kitchen unit 120. The fire door 116 preferably includes a fireproof, horizontally sliding door, which slides open to permit access to the oven and stove area 128 in the kitchen unit 120 or slides closed to seal off the oven and stove area 128 from the remainder of the kitchen unit 120. The fire door 116 preferably slides on rollers 132 inside an overhead track 134 and is operated by way of an electric motor 136. One possible version of the fire door 116 is depicted in FIGS. 4A-4C. A version of a kitchen unit 120 built out with a fire door 116 and other fire containment features is depicted schematically in FIG. 5 and is depicted in various perspective forms in FIGS. 6A-6E.

The fire protection system 104 cools and depletes oxygen from the affected area, for example, by spraying water, water droplets, or mist from an array of sprinklers 138. The fire protection system 104 might be a water mist fire protection system charged with clean water, and an example of one such system is commercially provided by Marioff Corporation under the HI-FOG® trademark.

The fire protection system 104 itself might include heat detectors or smoke detectors to automatically trigger the array of sprinklers 138. In such versions of the invention, the activated sprinkler 138 preferably sends a signal to the control system 102 so that other actions can be initiated (see, for example, causes 7 and 8 in FIGS. 2, 3F, and 3G. By way of example, a heat detector detecting a temperature of 70 degrees Celsius (158 degrees Fahrenheit) or more could automatically trigger one or more of the array of sprinklers 138.

Each manual call point 118 permits a user to manually signal the control system 102 of a possible emergency situation. The manual call point 118 could be a switch, button, lever, or other device known in the art for manually triggering a fire alarm. Upon receipt of the signal, the control system 102 initiates a response (effect) such as shown in FIG. 2.

In operation, the control system 102 receives a signal from a smoke detector 108, a heat detector 110, a manual call point 118, or an activated sprinkler 138. Based on which of these signals is received by the control system 102, the control system 102 initiates one or more predetermined actions, such as those indicated in FIG. 2. For example, those actions could include automatically closing the kitchen unit's fire door 116, triggering an alarm in the affected space, triggering an alarm at the annunciator 122 at the ship's bridge or the emergency control room, closing the fire damper 114 in the exhaust duct 124, the ventilation damper 112 stopping the kitchen unit's ventilation, providing an indicator at the annunciator 122 that a fire damper 114 closed, providing an indication at the annunciator 122 that a fire door 116 closed, cutting electrical power to the kitchen unit 120 while maintaining emergency lighting, activating sprinklers 138 in one or more locations, and closing other fire dampers 114 near the affected area. Consequently, the fire containment and monitoring system 100 will contain the fire, smoke, fumes, or excessive heat, and the potential damage is reduced.

While the present invention has been described with regards to particular embodiments, it is recognized that additional variations of the present invention may be devised without departing from the inventive concept. Additionally, although particularly designed for use on ships, the system described could also be used onboard watercraft of any size, aircraft, and trains.

### INDUSTRIAL APPLICABILITY

This invention may be industrially applied to the development, manufacture, and use of systems that provide monitoring and containment of fires, smoke, heat, and fumes, particularly those systems onboard watercraft.

What is claimed is:

1. A fire containment and monitoring system for use onboard a watercraft having a plurality of passenger apartments, each apartment having a kitchen unit with an oven and stove area and an exhaust duct, the fire containment and monitoring system comprising:
(a) an array of alarms, each alarm comprising an audible or visual indicator of a possible emergency situation in an affected area;
(b) an array of smoke detectors, each passenger apartment having at least one smoke detector, each smoke detector being configured to measure a detected smoke level and generate a smoke detector signal when the detected smoke level increases beyond a preselected smoke limit, and at least one of the array of smoke detectors being located in the kitchen unit;
(c) an array of heat detectors, each passenger apartment having at least one heat detector, each heat detector being configured to measure a detected heat level and generate a heat detector signal when the detected heat level increases beyond a preselected heat limit, and at least one of the array of heat detectors being located in the kitchen unit and in the oven and stove area;
(d) an array of manual call points, each passenger apartment having at least one manual call point, each manual call point comprising a manually operated device configured to generate a manual call point signal when activated;
(e) an array of ventilation dampers, each passenger apartment having at least one ventilation damper, the ventilation damper being configured to control the flow of ventilation air to and from the kitchen unit;
(f) an array of fire dampers, each passenger apartment having at least one fire damper in the exhaust duct for the kitchen unit, the fire damper being configured to block exhaust and embers from passing out of the kitchen unit through the exhaust duct;
(g) an array of fire doors, each passenger apartment having at least one fire door, each fire door being retractable, the fire door being configured to deploy automatically to enclose the oven and stove area, the fire door comprising a fireproof, horizontally sliding door, rollers running on an overhead track, and an electric motor to operate the fire door, the fire door configured to slide open to permit access to the oven and stove area and slide closed to seal off the oven and stove area from the remainder of the kitchen unit;
(h) an annunciator configured to indicate a status of each alarm, smoke detector, heat detector, ventilation damper, fire damper, fire door, and manual call point;
(i) a fire protection system to cool and deplete oxygen from the affected area,
(i) the fire protection system comprising an array of nozzles for spraying water; and
(j) a control system, the control system being in communication with the fire protection system and each alarm, smoke detector, heat detector, ventilation damper, fire damper, fire door, and manual call point, the control system being configured to receive the smoke detector signal, the heat detector signal, and the manual call point signal, and the control system being configured to initiate a responsive action upon receiving the smoke detector signal, the heat detector signal, or the manual call point signal, the responsive action selected from the group consisting of automatically closing a fire door within the array of fire doors, triggering one or more alarm within the array of alarms, closing a fire damper within the array of fire dampers, closing a ventilation damper within the array of ventilation dampers, providing an indicator at the annunciator that a fire damper was closed, providing an indication at the annunciator that a fire door was closed, cutting electrical power to the kitchen unit while maintaining emergency lighting, and activating the fire protection system.

2. A fire containment and monitoring system for use onboard a watercraft having a passenger apartment, the apartment having a kitchen unit with an oven and stove area and an exhaust duct, the fire containment and monitoring system comprising:
(a) an alarm comprising an alert indicator of a possible emergency situation in an affected area, the alert indicator being audible or visual;
(b) a smoke detector in the passenger apartment, the smoke detector being configured to measure a detected smoke level and generate a smoke detector signal when the detected smoke level increases above a preselected smoke limit;
(c) a heat detector in the passenger apartment, the heat detector being configured to measure a detected heat level and generate a heat detector signal when the detected heat level increases beyond a preselected heat limit;
(d) a ventilation damper in the passenger apartment, the ventilation damper being configured to control the flow of ventilation air to and from the kitchen unit;
(e) a fire damper in the exhaust duct for the kitchen unit, the fire damper being configured to block exhaust and embers from passing out of the kitchen unit through the exhaust duct;
(f) a fire door, the fire door being retractable, the fire door being configured to deploy automatically to enclose the oven and stove area, the fire door being configured to slide open to permit access to the oven and stove area and slide closed to seal off the oven and stove area from the remainder of the kitchen unit;
(g) an annunciator configured to indicate a status of the alarm, smoke detector, heat detector, ventilation damper, fire damper, and fire door;
(h) a fire protection system to cool and deplete oxygen from the affected area, the fire protection system comprising an array of nozzles for spraying water; and
(i) a control system, the control system being in communication with the fire protection system and the alarm, the smoke detector, the heat detector, the ventilation damper, the fire damper, and the fire door, the control system being configured to receive the smoke detector signal, and the heat detector signal, and the control system being configured to initiate a responsive action upon receiving the smoke detector signal, or the heat detector signal.

3. The fire containment and monitoring system of claim 2 further comprising a manual call point in the passenger apartment, the manual call point comprising a manually operated device configured to generate a manual call point signal when activated, the annunciator further being configured to indicate a status of the manual call point, the control system further being in communication with the manual call point, the control system further being configured to receive the manual call point signal, and the control system further being configured to initiate a responsive action upon receiving the manual call point signal.

4. The fire containment and monitoring system of claim 2, the smoke detector being located in the kitchen unit.

5. The fire containment and monitoring system of claim 2, the heat detector being located in the kitchen unit and in the oven and stove area and positioned to read a cooking top temperature.

6. The fire containment and monitoring system of claim 2, the fire door comprising a fireproof, horizontally sliding door, rollers running on an overhead track, and an electric motor to operate the fire door.

7. The fire containment and monitoring system of claim 2, the fire protection system comprising an array of nozzles for spraying water.

8. The fire containment and monitoring system of claim 2, the responsive action selected from the group consisting of automatically closing a fire door within the array of fire doors, triggering one or more alarm within the array of alarms, closing a fire damper within the array of fire dampers, closing a ventilation damper within the array of ventilation dampers, providing an indicator at the annunciator that a fire damper was closed, providing an indication at the annunciator that a fire door was closed, cutting electrical power to the kitchen unit while maintaining emergency lighting, and activating the fire protection system

9. A method for providing fire containment and monitoring for use onboard a watercraft having a passenger apartment, the apartment having a kitchen unit with an oven and stove area and an exhaust duct, the method comprising the steps of:
(a) providing a system comprising:
(i) an alarm having an audible or visual alert indicator;
(ii) a smoke detector;
(iii) a heat detector;
(iv) a ventilation damper;
(v) a fire damper;
(vi) a fire door;
(vii) an annunciator;
(viii) a fire protection system; and
(ix) a control system;
(b) placing the smoke detector, the heat detector, and the ventilation damper in the passenger apartment;
(c) placing the fire damper in the exhaust duct for the kitchen unit;
(d) configuring the smoke detector to measure a detected smoke level and to generate a smoke detector signal when the detected smoke level increases above a preselected smoke limit;
(e) configuring the heat detector to measure a detected heat level and to generate a heat detector signal when the detected heat level increases beyond a preselected heat limit;
(f) configuring the ventilation damper to control the flow of ventilation air for the kitchen unit;
(g) configuring the fire damper to block exhaust and embers from passing out of the kitchen unit through the exhaust duct;
(h) configuring the fire door to deploy automatically to enclose the oven and stove area, the fire door sliding open to permit access to the oven and stove area and sliding closed to seal off the oven and stove area from the remainder of the kitchen unit;
(i) indicating by the annunciator a status of the alarm, smoke detector, heat detector, ventilation damper, fire damper, and fire door;
(j) activating the fire protection system to cool and deplete oxygen from the kitchen unit by spraying water from an array of nozzles;
(k) the control system communicating with the fire protection system and the alarm, the smoke detector, the heat detector, the ventilation damper, the fire damper, and the fire door;
(l) the control system receiving the smoke detector signal, and the heat detector signal; and
(m) the control system initiating a responsive action upon receiving the smoke detector signal, or the heat detector signal.

10. The method of claim 9 further comprising:
(a) the step of providing a system further comprising providing a manual call point in the passenger apartment;
(b) the manual call point generating a manual call point signal when activated;
(c) the annunciator also indicating a status of the manual call point;
(d) the control system also communicating with the manual call point;
(e) the control system also receiving the manual call point signal; and
(f) the control system also initiating a responsive action upon receiving the manual call point signal.

11. The method of claim 9, the step of placing the smoke detector, the heat detector, and the ventilation damper in the passenger apartment further comprising installing the smoke detector in the kitchen unit.

12. The method of claim 9, the step of placing the smoke detector, the heat detector, and the ventilation damper in the passenger apartment further comprising installing the heat detector in the oven and stove area and positioning the heat detector to detect a cooking top temperature.

13. The method of claim 9, the fire door comprising a fireproof, horizontally sliding door, rollers running on an overhead track, and an electric motor to operate the fire door.

14. The method of claim 9, the fire protection system comprising an array of nozzles spraying water.

15. The method of claim 9, the responsive action selected from the group consisting of automatically closing a fire door within the array of fire doors, triggering one or more alarm within the array of alarms, closing a fire damper within the array of fire dampers, closing a ventilation damper within the array of ventilation dampers, providing an indicator at the annunciator that a fire damper was closed, providing an indication at the annunciator that a fire door was closed, cutting electrical power to the kitchen unit while maintaining emergency lighting, and activating the fire protection system.
